(19) United States
(12) Patent Application Publication
(10) Pub. No.: US 2013/0314255 A1
(43) Pub. Date: Nov. 28, 2013

(54) Enhanced Barrel Mounted Traffic Message Board Systems And Methods

(71) Applicant: Llewellyn Richard BEnn, Brooklyn, NY (US)

(72) Inventor: Llewellyn Richard BEnn, Brooklyn, NY (US)

(21) Appl. No.: 13/894,371

(22) Filed: May 14, 2013

Related U.S. Application Data
(60) Provisional application No. 61/646,499, filed on May 14, 2012.

(51) Int. Cl. G08G 1/0955

(52) U.S. Cl. CPC G08G 1/0955
USPC 340/908

(57) ABSTRACT

Systems and methods disclose an enhanced barrel mounted traffic message board system for displaying information to traffic. A traffic message board is adjustably coupled to a pole and configured to display the traffic information to the traffic. A battery provides power to the traffic message board and a solar panel provides power to the battery. A traffic barrel is positioned around the pole and over a base plate that supports the pole. An internal structure positioned within the barrel couples with the base plate to provide support to the pole.

### RELATED APPLICATIONS

This application claims priority to U.S. Provisional Patent Application Ser. No. 61/646,499, titled “Barrel Mounted traffic Message Board”, filed May 14, 2012, and incorporated herein by reference.

### BACKGROUND

Conventional traffic message boards are mounted and transported on trailers or on the rear of trucks. Such displays are typically large and heavy and are not convenient for rapid deployment or for use in areas of restricted size. For example, where construction is done within a narrow street, a conventional trailer or truck based traffic message board cannot be positioned in an optimal position without blocking the traffic.

In a prior co-owned invention (U.S. patent application Ser. No. 12/203,820), a traffic message board mounted directly to a traffic barrel is discussed. However, the design provided no flexibility in mounting height of the traffic message board, and provided inadequate structural integrity for the intended use of the barrel mounted traffic message board.

### SUMMARY OF THE INVENTION

The embodiments shown and described herein provide substantial and novel improvement over the traffic message board mounted directly to the traffic barrel. That is, the embodiments herein may include all features described in U.S. patent application Ser. No. 12/203,820 and may include additional features that enhance the state of the art over the previous disclosure. For example, the added novel internal structure of the enhanced barrel mounted traffic message board system provides substantially more support for the traffic message board, flexibility in mounting height of the traffic message board display, and added safety in the event of a vehicle colliding with the enhanced barrel mounted traffic message board system.

In one embodiment, an enhanced barrel mounted traffic message board system displays information to traffic. The system includes a pole, a traffic message board adjustably coupled to the pole and configured to display the traffic information to the traffic, a battery for providing power to the traffic message board, a solar panel for providing power to the battery, a traffic barrel, a base plate, and an internal structure positioned within the barrel and coupled to the base plate to provide support to the pole.

In another embodiment, an enhanced Jersey barrier mounted traffic message board system displays information to traffic. The system includes a pole, a traffic message board for displaying the information to the traffic, wherein the traffic message board is adjustably coupled to the pole, a battery for providing power to the traffic message board, a solar panel for providing power to the battery, and a bracket for coupling the pole to the Jersey barrier.

In another embodiment, a method displays traffic information. A pole is attached to a base plate such that the pole is substantially vertical. A traffic message board is attached to the pole and displays the traffic information. A solar panel is attached to the top of the pole, and a traffic barrel is positioned around the pole and over the base plate.

### BRIEF DESCRIPTION OF THE FIGURES

FIG. 1 shows a front view of one exemplary enhanced barrel mounted traffic message board system, in an embodiment.

FIG. 2 is a side view of the enhanced barrel mounted traffic message board system of FIG. 1.

FIG. 3 is front elevation of an enhanced barrel mounted traffic message board system, in an embodiment.

FIG. 4 is a rear elevation of the enhanced barrel mounted traffic message board system of FIG. 3.

FIG. 5 shows an alternative post based Jersey barrier mounting for the traffic message board system of FIGS. 3 and 4.

FIGS. 6 and 7 show a brochure for an exemplary enhanced barrel mounted traffic message board system, in an embodiment.

FIGS. 8 and 9 show an exemplary enhanced barrel mounted traffic message board system, in an embodiment.

### DETAILED DESCRIPTION OF THE EMBODIMENTS

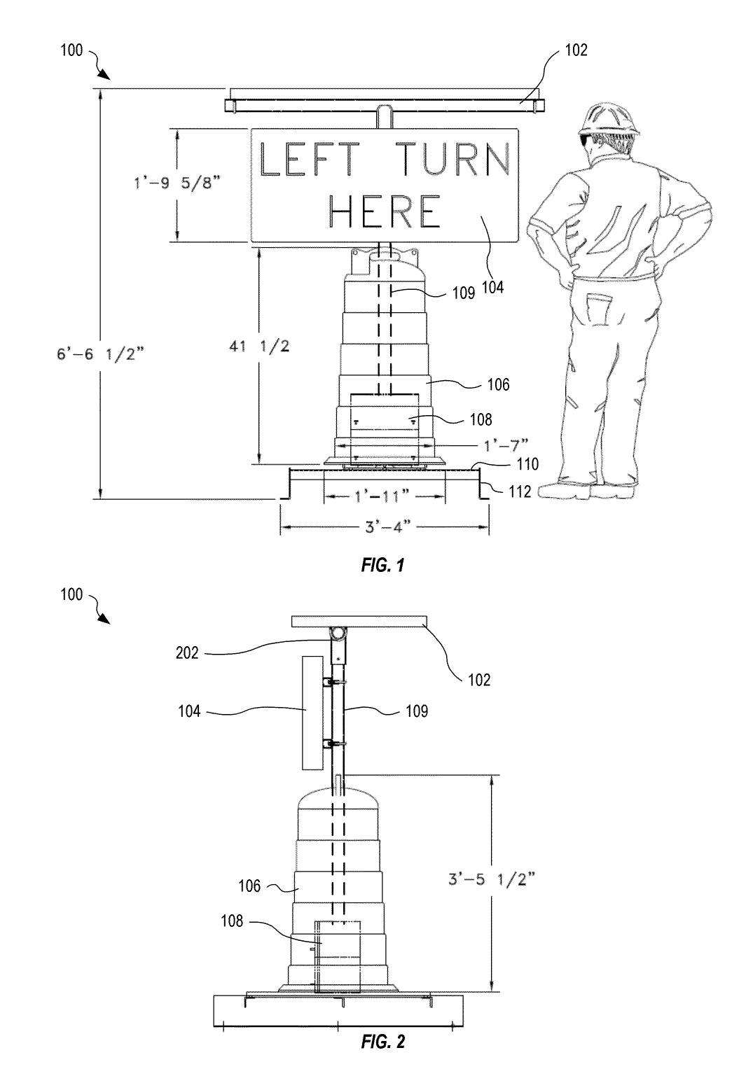

FIG. 1 shows a front view of one exemplary enhanced barrel mounted traffic message board system 100. Enhanced barrel mounted traffic message board system 100 has a solar panel 102, a message board 104, a pole 109, and a traffic barrel 106 that has an internal support structure 108 that may allow barrel mounted traffic message board system 100 to conform to department of transport collision requirements. FIG. 2 is a side view of barrel mounted traffic message board system 100 of FIG. 1, showing a hinged/swivel mount 202 of solar panel 102 that attaches to pole 109 to provide optimal orientation or solar panel 102. FIGS. 1 and 2 are best viewed together with the following description.

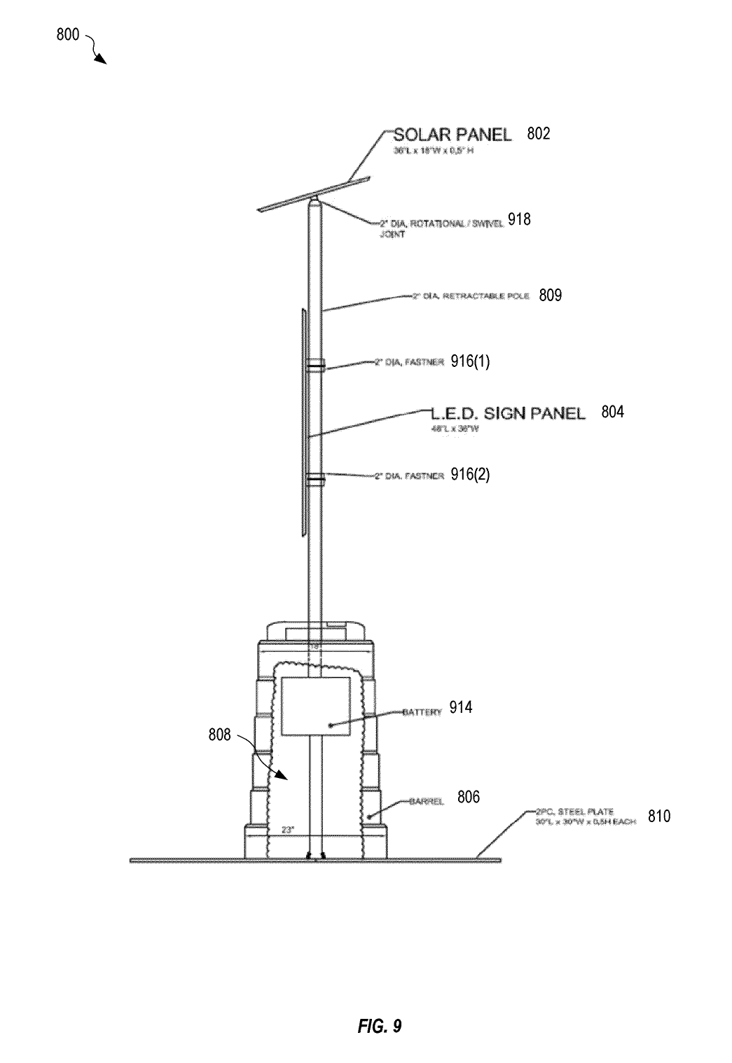

Internal support structure 108 attaches to pole 109 that extends through the top of barrel 106 and to which message board 104 and solar panel 102 attach. Pole 109 thereby provides height adjustment to one or both of message board 104 and solar panel 102. Internal support structure 108 may provide ballast that prevents enhanced barrel mounted traffic message board system 100 from becoming unstable and tipping over in strong wind or when accidentally struck by a vehicle. Optionally, internal structure 108 may house a battery (see FIGS. 8 and 9) that is used to power message board 104 and that receives power from solar panel 102.

In one embodiment, internal structure 108 is supported by, and optionally attaches to, a base plate 110 that may be attached to a rim 112 such that base plate 110 and rim 112 provide a base for enhanced barrel mounted traffic message board 100. Internal structure 108 attaches to and supports pole 109. Barrel 106 provides a cover for internal structure 108 and enhances recognition of enhanced barrel mounted traffic message board system 100 by vehicle drivers. Advantageously, the enhanced barrel mounted traffic message board systems 100 are portable and do not require a trailer mount, since they may weigh 150 lbs or less.

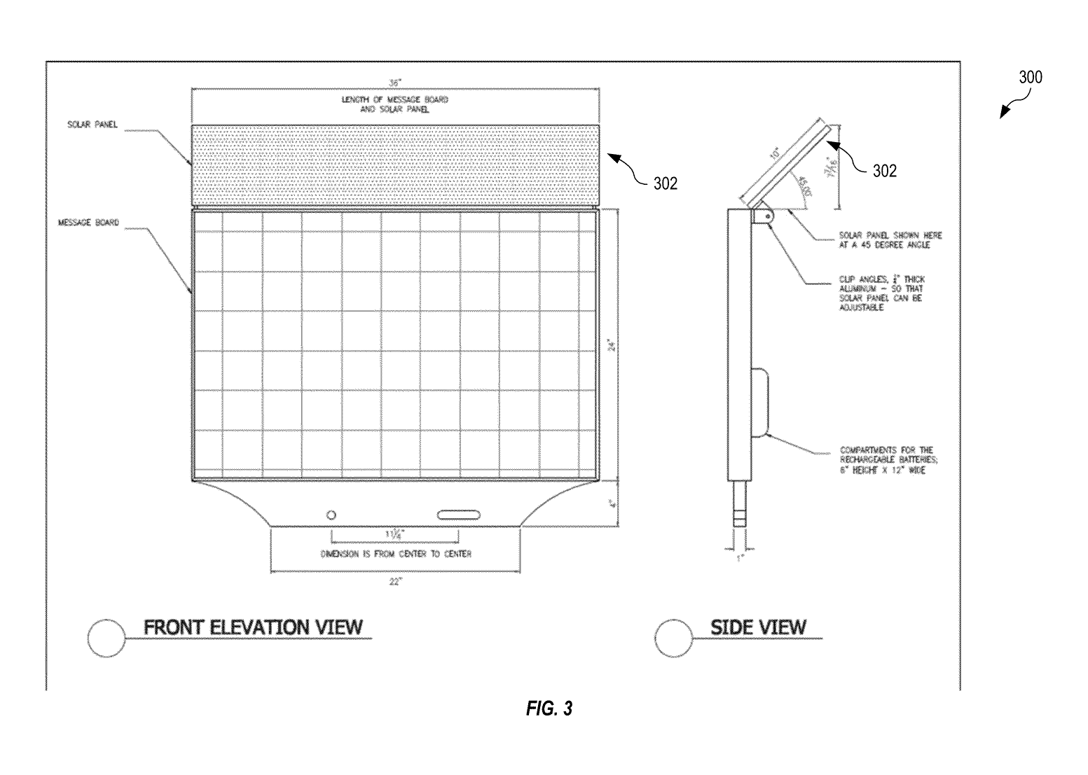

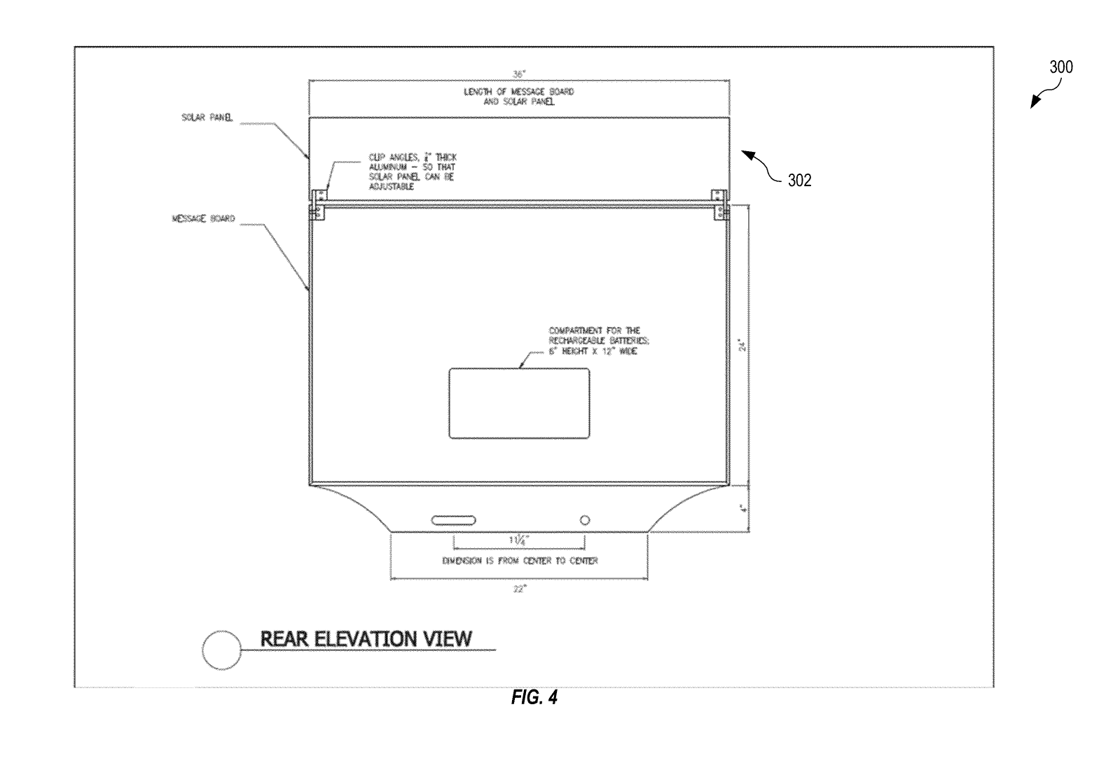

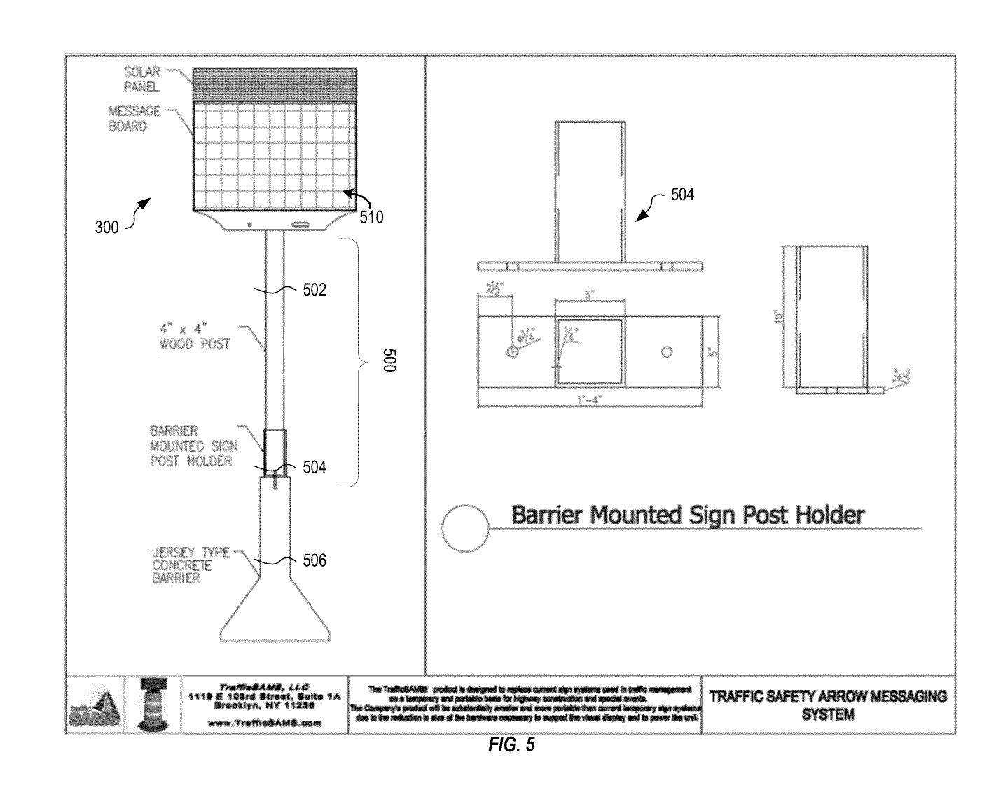

FIG. 3 shows a front elevation and a side elevation of a pole mountable traffic message board 300. FIG. 4 shows a rear elevation of the traffic message board 300 of FIG. 3. FIG. 5 shows a post based Jersey barrier mounting 500 for supporting traffic message board 300 of FIGS. 3 and 4. Traffic message board 300 includes a solar panel 302 and is mounted on a post/pole 502 that couples, using an adapter 504, to a Jersey barrier 506. Solar panel 302 is electrically coupled to, and provides power to, a battery 510 located in a housing behind message board 300.

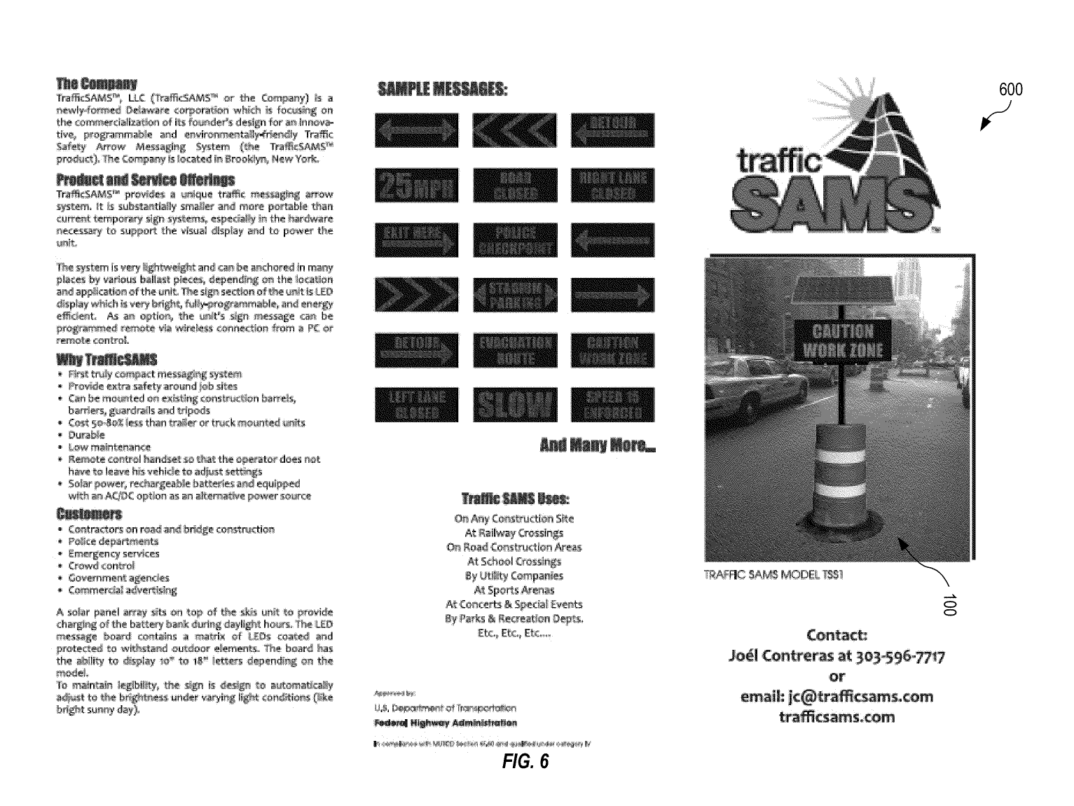

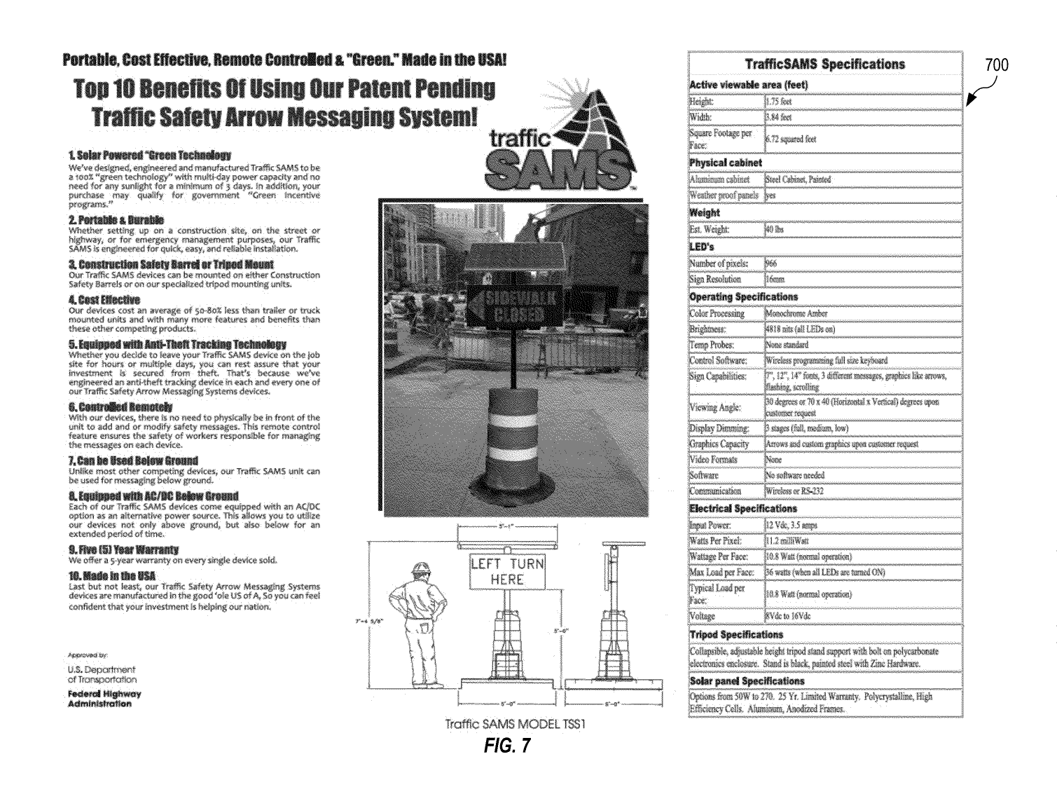

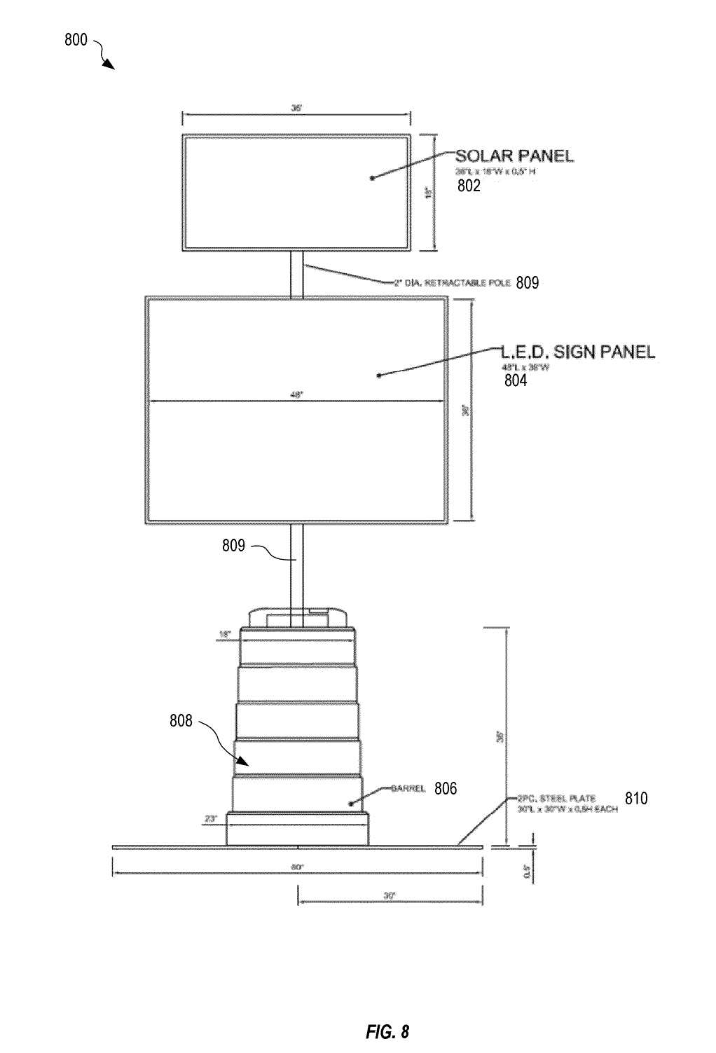

FIGS. 6 and 7 show an outside portion 600 and an inside portion 700 of an exemplary brochure for a barrel mounted traffic message board system. Inside and outside portions 600, 700 contain exemplary information of barrel mounted traffic message board system 100 of FIGS. 1 and 2.

FIG. 8 is a front elevation showing one exemplary enhanced barrel mounted traffic message board 800, in an embodiment. FIG. 9 is a side elevation showing the enhanced barrel mounted traffic message board 800 of FIG. 8. FIGS. 8 and 9 are best viewed together with the following description.

System 800 includes a solar panel 802, a traffic message board 804, a barrel 806, internal structure 808, a pole 809, and a base plate 810. Base plate 810 attaches to internal structure 808 that includes pole 809 such that pole 809 passes substantially vertically through the top of barrel 806. Traffic message board 804 attaches to pole 809 using one or more clips 916 for example. Clips 916 allow height of traffic message board 804 to be adjusted on pole 809. Optionally, pole 809 is a retractable pole that further allows height of traffic message board 804 and solar panel 802 to be adjusted.

Barrel 806 may enclose a rechargeable battery 914 that powers traffic message board 804 and receives power from solar panel 802. Solar panel 802 couples to a rotational swivel joint 918 that allows solar panel 802 to be optimally positioned to capture solar energy.

Further Exemplary Detail

Exemplary components of the enhanced barrel mounted traffic message board systems 100 and 800, and the pole mountable traffic message board 300 include:

LED red and amber modules: 24 pcs 96*128 cm

iron waterproof cabinet: 1 pc

power supply with UL: 4 pcs 5v 40 A/pc

GSM control card: 1 pc

wireless GSM moblie control

on-demand card: 1 pc via usb, remote choose program

1 pc remote and receiver for on-demand card

switch of AC110V and solar energy: 2 pcs

switch of two kinds of control card: 1pc

accessory: CD, USB, DATA CABLE LINE

P10 led message board

pixel pitch: 10 mm

pixel: 96*128 dots

composed of pixel: 1R1A

display size: 96*128*10 cm

cabinet size: 96*128*10 cm

area of full panel: 1.2288 sqm

waterproof cabinet colour: black

power supply: AC110V

solar energy battery: 5v 120A

power: 600w

brightness: 2000 mcd/sqm

Beam Angle: 50˜120

packing: wooden case

Additional features of barrel mounted traffic message board 100 may include:
Video playback. The traffic message board may display a sequence of video frames.
Still Picture playback. The traffic message board may display a slide show of still pictures.
Color option. The traffic message board may be configured to display color.
Rain sensor. The traffic message board may include a rain sensor, wherein the displayed message is selected based upon the sensed rain.
Temperature sensor. The traffic message board may include a temperature sensor that measures ambient temperature, wherein the displayed message is selected based upon the sensed temperature.
Audio output. The traffic message board may include an audio output (e.g. a speaker). The audio output allows use of the traffic message board in other environments, such as a train station, and other situations such as an emergency where audio instructions may be provided to the public.
Low battery indicator. The traffic message board may include an indicator of low battery level.
Double sided display. The traffic message board may be double sided, wherein information is imparted to traffic passing in both directions.
Jersey barrier mount. As shown in FIG. 5, the traffic message board may mount to a Jersey barrier.
Triton Barrier mount. The traffic message board may include means for mounting to a Triton barrier.
Solar is mounted at top and hinged/pivoted to allow positioning. The traffic message board may include a hinge and/or pivot mechanism that allows the solar panel to be positioned for optimal solar collection.
Selectable play modes. The traffic message board may include multiple display modes that are selectable.
USB interface. The traffic message board may include a USB interface that allows programming using a Personal Computer.
Wi-Fi interface. The traffic message board may include a wireless Wi-Fi interface that allows programming using a Personal Computer.
GPS receiver. The traffic message board may include a GPS receiver that monitors its position such that it may detect when it is moved without authorization (e.g., stolen).
Alarm. The traffic message board may include an alarm to provide warning to nearby traffic and/or workers. For example, the device may sound the alarm if device is moved from a set location (e.g., as determined using the GPS receiver)—even if display is turned off.
A wireless communication interface (e.g., Wi-Fi) that forms an ad-hoc network with other Barrel mounted traffic message boards such that a coordinated display may be presented across multiple units for easier viewing of moving vehicles.
An programming interface. The traffic message board may include an interface to allow a portable device (e.g., a smart phone) to program the display (and may include protection to prevent unwanted programming).
Deactivator. The traffic message board may include a deactivation unit that makes the display unusable if stolen.

Changes may be made in the above methods and systems without departing from the scope hereof. It should thus be noted that the matter contained in the above description or shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. An enhanced barrel mounted traffic message board system for displaying information to traffic, comprising:
a pole;
a traffic message board for displaying the information to the traffic, wherein the traffic message board is adjustably coupled to the pole;
a battery for providing power to the traffic message board;
a solar panel for providing power to the battery;
a traffic barrel;
a base plate; and
an internal structure positioned within the barrel and coupled to the base plate to provide support to the pole.

2. The system of claim 1, wherein the internal structure includes a housing for the battery.

3. The system of claim 1, wherein the pole is retractable.

4. An enhanced Jersey barrier mounted traffic message board system for displaying information to traffic, comprising:
a pole;
a traffic message board for displaying the information to the traffic, wherein the traffic message board is adjustably coupled to the pole;
a battery for providing power to the traffic message board;
a solar panel for providing power to the battery; and
a bracket for coupling the pole to the Jersey barrier.

5. A method for displaying traffic information, comprising the steps of:
attaching a pole to a base plate such that the pole is substantially vertical;
attaching a traffic message board to the pole, wherein the traffic message board displays the traffic information;
attaching a solar panel to the top of the pole; and
positioning a traffic barrel around the pole and over the base plate.
